(19) United States
(12) Patent Application Publication
(10) Pub. No.: US 2014/0247986 A1
(43) Pub. Date: Sep. 4, 2014

(54) METHOD FOR SEGMENTING A SOURCE IMAGE

(71) Applicant: UNIVERSITÉ DU SUD TOULON-VAR, La Garde (FR)

(72) Inventors: Frédéric Bouchara, Toulon (FR); Thibault Lelore, Marseille (FR)

(73) Assignee: Universite du Sud Toulon-var, La Garde (FR)

(21) Appl. No.: 13/261,857

(22) PCT Filed: Nov. 14, 2012
(86) PCT No.: PCT/IB2012/056425

§ 371 Date: May 14, 2014

Related U.S. Application Data
(60) Provisional application No. 61/559,298, filed on Nov. 14, 2011.

(51) Int. Cl. G06T 7/00

(52) U.S. Cl. CPC G06T 7/0079
USPC 382/173

(57) ABSTRACT

The present invention concerns a method for segmenting a source image containing an object on a background. The invention produces a possibly binary representation according to which each pixel is associated with an attribute indicating that the pixel describes the object or the background. The segmentation of the image is based on a sub-process to estimate the respective probabilities of describing the object rather than the background of pixels of interest alone—i.e. those located in the proximity of transitions between pixel regions describing the object and those describing the background. A representation RV is associated with said image to indicate said probabilities.

The present invention concerns a method for segmenting a digital image containing text or more generally, an object on a background. The invention is used to produce a possibly binary representation according to which each pixel is assigned a dedicated attribute indicating that the pixel describes an object or text object rather than the background. Said representation may be interpreted in the form of a resulting image for which each pixel may be described by the value of a bit encoding the presence or absence of a text object or other object. While it may have many uses, the invention will ideally be applied in the segmentation of natural images which include text, as well as digitised typographic documents and manuscripts which have been severely degraded or multi-spectral images of historic documents.

The segmentation or “binarization” of a source image constitutes an important step for a variety of methods such as optical character recognition, image compression and delimiting zones of interest . . . . This step eliminates useless information while preserving that which is of interest: e.g. text included in a manuscript document. The accuracy of these methods is directly associated with the quality of the segmentation to sort the useful information from the noise.

This operation is commonly hampered by the presence of noise in the source image to be segmented. This may take different forms (speckling, reflections, shadows, blurring etc.) Classic segmentation methods generally lose part of the useful information or consider noise to be part of the text or the object.

Furthermore, a document which one wishes to segment may present text which is printed or written in different forms (exotic or varying fonts, different sizes of fonts, different text orientations etc.). Traditional methods—based on learning or studying the adjacent pixels in an analysis window—are unsuitable for processing these types of documents.

Furthermore, the complexity of the processes implemented by image segmentation systems generally make it impossible to use advanced methods on systems with limited processing and/or storage capabilities, such as mobile devices (Smart phones, tablets, laptops etc.).

This invention resolves the inconveniences of the known methods and systems by optimising the methods implemented by a processing unit of an image segmentation system. The latter is able to segment a source image with very high performance and accuracy even when processing capabilities and storage means are limited.

To this end, the invention provides a method to classify the pixels of a source image describing an object on a background. Such a method is to be performed by a processing unit of an image segmentation system, said processing unit cooperating with storage means. In order to optimise the analysis of source image pixels, the method comprises a step to produce and store in the storage means a likelihood representation of said source image associating a likelihood attribute with each pixel of the source image, the value of which corresponds to the probability that said pixel describes the object rather than the background. According to the invention, this step comprises:
a step to initialise the respective likelihood attribute values to a predetermined value indicating that the pixel is undetermined;
a step to detect a transition between a first and a second pixel region respectively describing the object and the background according to a given sensitivity parameter and to produce and then store in storage means a transition representation of the source image associating each pixel of the source image with a transition attribute indicating whether the pixel corresponds to a detected transition or not;
a step to estimate the respective probabilities to describe the object rather than the background of pixels for which the respective distance separating them respectively from a pixel corresponding to a detected transition is less than or equal to a predetermined value and to replace the likelihood attributes respectively associated with them by said estimates.

According to a preferred embodiment, the likelihood attribute value corresponding to a probability that a pixel describes the object rather than the background is advantageously a real number between 0 and 1 and the predetermined value of a likelihood attribute corresponding to an undetermined pixel is equal to 0.5.

If needed, in order to improve the selection of pixels of interest, such a method may comprise a step to produce and store in storage means a consolidated likelihood representation of said source image associating with each pixel of the source image a likelihood attribute corresponding to a probability that the pixel describes the object rather than the background. Said step may consist in:
a step to perform a first instance of a classification method according to the invention for which a sensitivity parameter is chosen in order to prevent any false detection of transitions, said implementation producing a first likelihood representation of the source image;
a step to perform a second instance of a classification method according to the invention for which a sensitivity parameter is chosen in order to prevent undetected transitions, said implementation producing a second likelihood representation of the source image;
a step to produce and store the consolidated likelihood representation of said source image assigning to each likelihood attribute of said consolidated representation the respective values of the likelihood attributes of the first likelihood representation then replacing the likelihood attribute values of the consolidated representation by the likelihood attribute values of the second likelihood representation if, and only if, said values are strictly higher than a certain threshold.

The invention also provides an alternative embodiment to improve the classification of the pixels of a source image. According to this alternative embodiment, the storage means store first and second source images describing the same object on the same background. The first and second source images are captured using capture means which are displaced a non-zero displacement distance between each capture. A classification method according to the invention may comprise, in this case, a step to produce and store in the storage means a consolidated likelihood representation of the first source image associating each pixel of said image with a likelihood attribute corresponding to the probability that the pixel describes the object rather than the background, said step consisting in:
a step to a first instance of a method according to any of the preceding claims to produce a likelihood representation of the first source image;
a step to a second instance of a method according to any of the preceding claims to produce a likelihood representation of the second source image;
a step to estimate the displacement distance and to determine the matching of the pixels of the two images;
a step to produce and store the consolidated likelihood representation assigning the respective likelihood attribute values of the first likelihood representation to each likelihood attribute of said consolidated representation, then replacing the likelihood attribute values of the consolidated representation with a linear combination of the likelihood attribute values corresponding to the first and second likelihood representations.

According to this last alternative embodiment, the classification method may advantageously comprise a prior step to increase the resolution of the two images by interpolation and to respectively replace the source images with the interpolated images.

In order to improve the pertinence of the produced likelihood representation, the invention provides for a classification method to comprise a step to produce a filtered likelihood representation, said step comprising:
a step to interpret the likelihood representation and to identify all directly adjacent pixel pairs, the first describing the object and the second being undetermined;
a step to initialise a transition representation of the source image in which only the values of transition attributes respectively associated with pixels of the source image respectively adjoining said pixel pair, as well as those of the values of the transition attributes associated with said pixel pair, indicate that the pixels correspond to a detected transition;
a step to estimate the respective probabilities to describe the object rather than the background of pixels respectively associated with transition attributes indicating that said pixels correspond to a detected transition and for which the distance—respectively separating them from one of the pixels for which the value of the transition attribute indicates that said pixel corresponds to a detected transition—is less than or equal to a predetermined value and to replace the likelihood attributes respectively associated with them by said estimates.

According to a second objective and particularly to process undetermined pixels, the invention provides for a method to segment a source image describing an object on a background, said method being performed by a processing unit of an image segmentation system, said processing unit cooperating with storage means and comprising a step to produce a binary representation of the source image associating an attribute with each pixel of said source image, the value of which is a predetermined value associated with the background or a predetermined value associated with the object. The method comprises:
a step to classify the pixels of the source image using a method according to the invention in order to obtain a likelihood representation of the source image associating a likelihood attribute with each pixel of the source image the value of which corresponds to the probability that said pixel describes the object rather than the background;
a step to characterise a region of connected pixels respectively associated with likelihood attributes, the values of which indicate that they are undetermined, replacing the values of said likelihood attributes with the average of the likelihood attribute values respectively associated with the boundary pixels for which the respective likelihood attribute values are different from the value indicating indeterminacy.

In order to produce the binary representation, such a method may comprise a step thresholding the likelihood representation so obtained in order to produce the binary representation by assigning predetermined values respectively associated with the background or with the object to its attributes when the values of the corresponding likelihood attributes are strictly below the background threshold or above the object threshold.

In a preferred example, the predetermined values respectively associated with the background and the object may be 0 and 1.

Similarly, the threshold for the background and the threshold for the object may advantageously be respectively set at 0.5.

According to a third objective, the invention provides for a computer program comprising a plurality of instructions operable by a processing unit of a segmentation system, said program being intended to be stored in storage means cooperating with said processing unit, said instructions triggering the performance of a method according to the invention when executed or interpreted by the processing unit.

Furthermore, the invention provides for the use of non-volatile storage means containing the instructions of such a computer program.

Other characteristics and advantages will become apparent on reading the following description and examining the supporting figures, which include:

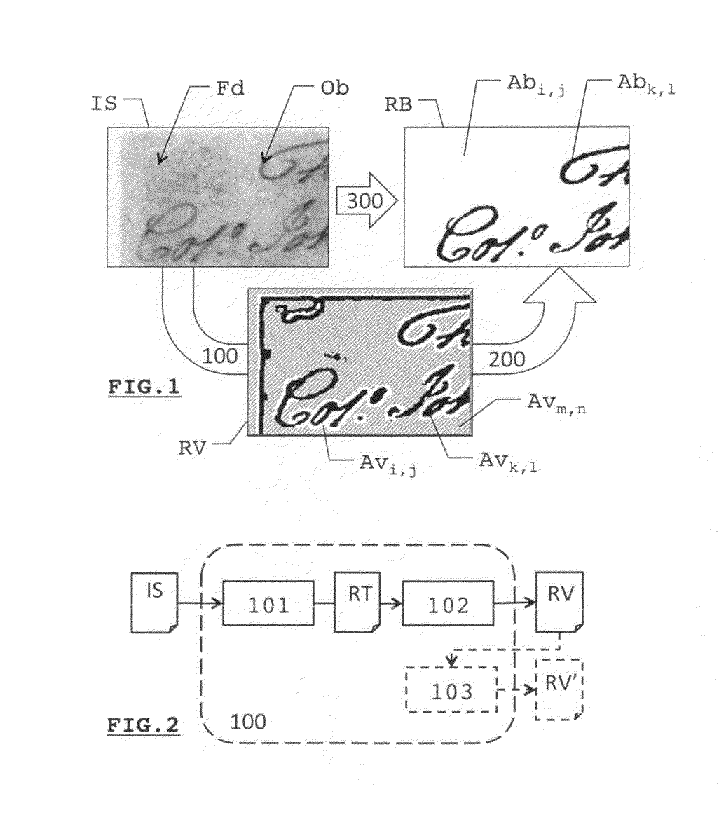

FIGS. 1 and 6 respectively presenting a schematic and a block diagram of an image segmentation method according to the invention;

FIGS. 2, 3 and 4 presenting implementations of a method—according to the invention—to classify pixels of interest in a source image;

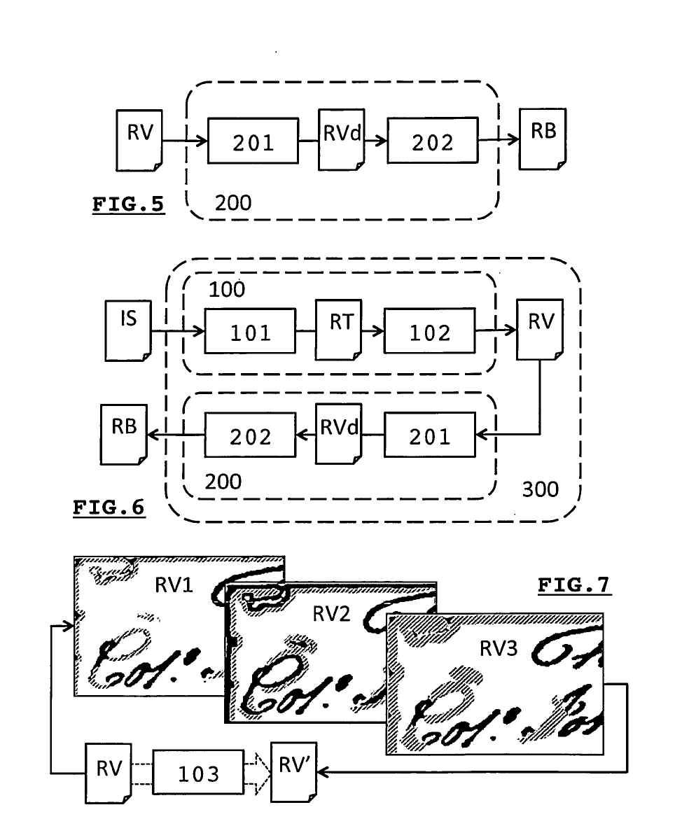

FIG. 5 describing a block diagram of a method according to the invention to produce a binary representation of a source image;

FIG. 7 presenting a schematic of an optional filtering step according to the invention.

FIG. 1 describes a schematic of a method according to the invention to segment a source image.

The purpose of such a process 300 is to segment a source image IS resulting—for example—from the capture of a scene or the digitisation of a document presenting an object on a background. In FIG. 1, the image IS corresponds to the digitisation of a portion of a page of manuscript. The object Ob is in this case a hand-written text. The image IS presents said image on a nonhomogenous background Fd. The performance of a segmentation method by a processing unit of a segmentation system (system not shown in FIG. 1) consists in producing a binary representation RB of the source image IS. Such a representation associates an attribute with each pixel the value of which indicates whether said pixel describes the object or the background. Such a binary representation may be interpreted as a binary image according to which each pixel may be encoded in one bit (said pixel describing the object or the background). As such, as shown in FIG. 1, the segmentation method 300 produces an image, or more generally a representation RB of the source image IS which associates a binary attribute Ab_{x,y} with pixel P_{x,y} (with coordinates (x,y) on a virtual grid) of the source image IS. The attribute Ab_{i,j} comprises a value equal to a predetermined value (“0” for example) characterising a pixel P_{i,j} describing the background Fd. Conversely, the attribute Ab_{k,l} comprises a value equal to a predetermined value (“1” for example) characterising a pixel (P_{k,l} in this instance) describing the text.

In order to reduce the processing time and to optimise the physical resources of an image segmentation system, the invention provides that all the pixels of the source image are not processed in the same manner. Indeed, as is shown in FIG. 1, the pixels describing the background are far more numerous than those describing the object (the text). The invention provides a system which focuses primarily on a sub-set of pixels of interest rather than all pixels of the source image.

The segmentation method 300 according to the invention is therefore based on a classification method 100 classifying only the pixels adjoining transitions between the object Ob and the background Fd. The latter are processed in order to estimate the respective probabilities of describing the object rather than the background. Pixels which are not close to transitions between the object and the background are not examined by the classification method 100. They remain undetermined. The probability estimation step may be time-consuming and therefore prohibitive when iteratively performed by a mobile device. The invention aims to reduce the number of estimations required to segment an image in fine. A method according to the invention is therefore ideally intended to be performed by a processing unit of an image segmentation system with limited physical resources (in terms of processing and/or storage means). Whatever the processing capabilities, the invention minimises the duration of the image segmentation operation by focusing primarily on pixels of interest. Such a method produces an intermediate representation, said likelihood representation RV associating a likelihood attribute Av_{x,y} with each pixel of interest P_{x,y} the value of which indicates the probability that said pixel describes the object rather than the background. By way of example, FIG. 1 shows a likelihood representation RV which can be interpreted in the form of a ternary image. According to one embodiment of the invention, it is possible to implement a technique for thresholding the RV representation such that the likelihood attributes have only three possible values: a predetermined value indicating that the pixel probably describes the object, a predetermined value indicating that the pixel probably describes the background and a predetermined value indicating that the pixel has not been analysed and that it remains undetermined. As such, according to the representation RV described in FIG. 1, the value of the attribute Av_{i,j} (which is associated with pixel P_{i,j} of the source image IS), indicates that the pixel describes the background (white in colour). Conversely, the attribute Av_{k,l} (which is assigned to pixel P_{k,l} of the source image IS) indicates that the pixel it is associated with describes the object (black in colour). Lastly, the attribute Av_{m,n} indicates that pixel P_{m,n} of the source image is undetermined. The hatched regions—on the image interpreting the RV representation—correspond to these pixels. However, this operation to threshold the likelihood representation RV remains optional.

In order to produce a binary representation RB, the segmentation method 300 implements a method 200 exploiting the likelihood representation RV produced beforehand in order to process the remaining undetermined pixels. According to the invention, the operations to determine which pixels are “ignored” by the classification process 100 are performed on regions, from one to the next, and do therefore not overly consume resources compared to the operations to estimate the respective probabilities of describing the object from the various pixels of interest. This method 200 produces the binary representation RB which can be stored in the storage means cooperating with a processing unit of the segmentation system using the method 200.

FIG. 2 describes a block diagram of a first embodiment according to the invention of a method to classify pixels of interest in a source image presenting an object on a background. Such a method 100 consists in producing and storing in the storage means of a source image segmentation system, a likelihood representation RV of a source image IS. This representation RV associates a likelihood attribute with each pixel of said image the value of which corresponds to the probability that the pixel describes the object rather than the background. The classification comprises a first step (not shown in FIG. 2) to initialise the respective likelihood attribute values to a predetermined value indicating that the pixel is undetermined. Preferably this value may advantageously be equal to 0.5 (½), the estimated probability varying between 0 and 1 (or 0 and 100%) inclusive.

In order to focus on pixels of interest, the classification method 100 comprises a step 101 to detect a transition between the first and second pixel regions respectively describing the object and the background according to a given sensitivity parameter K. The objective here is to determine the contour of an object. We therefore obtain a transition representation RT of the source image associating a transition attribute with each pixel of the source image indicating whether the pixel corresponds or does not correspond to a detected transition. The transition representation produced may be stored in the storage means.

In order to be able to detect transitions, the invention preferably uses the Canny edge detector. This is a well-known algorithm which is configured using two thresholds, Th and Tb defining the sensitivity of transition detection.

For example, it is possible to reduce the number of sensitivity parameters to a single parameter K by calculating the Th threshold using the Otsu method (applied to a gradient image being defined as an image of local pixel-value variations) applying Th=K*To, To being the threshold calculated using the Otsu method. The Tb threshold may be deduced from Th using a simple linear relationship of the type Tb=0.4*Th. Any other method. for detecting transitions or contours may be used in other embodiments.

The classification method 100 also comprises a step 102 to interpret the transition representation RT produced in 101. This step consists in estimating for only those pixels adjoining a transition, the probabilities that they respectively describe the object rather than the background. A window of predetermined dimensions (e.g. ten pixels by ten pixels) can be specified which can be applied virtually on the source image. Once in position the window defines a set of connected pixels captured by said window. The classification method according to the invention advantageously “positions” the window around a pixel with which a transition attribute is associated indicating that said pixel describes a transition. More generally, this step estimates the respective probabilities to describe the object rather than the background of the pixels for which the respective distance separating them from a pixel corresponding to a detected transition is less than or equal to a predetermined value and to replace the likelihood attributes respectively associated with them by said estimates.

To estimate the respective probabilities, a classification method according to the invention may, by way of example and among other methods, use a classification algorithm. Indeed, as the method only processes zones located around contours or transitions detected in 101, an analysis window must necessarily contain both pixels describing the background and pixels describing an object. This set of pixels may therefore be considered as a mixture of two processes. If one simply assumes that these are Gaussian processes, it is possible to perform the classification using the well-known EM algorithm (expectation-maximisation). Alternatively, step 102 may be performed by implementing the K-means algorithm, so advantageously accelerating the estimation calculations.

At the end of step 102, the pixels of interest (those adjoining the transitions detected in 101) are respectively associated with dedicated likelihood attributes the values of which correspond to the probabilities that the pixels of interest describe the background or describe the object. The set of likelihood attributes associated with the pixels of the source image constitute the likelihood representation RV. As is shown in FIG. 1, it is possible—for example to be able to interpret such a representation RV in the form of an image—to “ternarise” the RV, meaning to perform a step thresholding the representation RV such that the likelihood attributes do not have more than three possible values: a predetermined value indicating that the pixel probably describes the object (“1” for example), a predetermined value indicating that the pixel probably describes the background (“0” for example), and a predetermined value indicating that the pixel has not been analysed and that it remains undetermined (“½” for example). One then obtains a representation RV as described in FIG. 1. This thresholding step is not necessary or indispensable when attempting to segment the source image.

FIG. 2 also describes an alternative embodiment of a classification method 100. According to this alternative embodiment, the method comprises a step 103 to produce a filtered likelihood representation RV′. This step primarily consists in:
1) interpreting the likelihood representation RV produced in 102 and identifying all directly adjacent pixel pairs, the first of which describes the object, the second being undetermined;
2) the initialisation of a transition representation of the source image in which only the values of transition attributes respectively associated with pixels of the source image respectively adjoining said pixel pair, as well as those of the values of the transition attributes associated with said pixel pair indicate that the pixels correspond to a detected transition;
3) a new estimation of the respective probabilities of describing the object rather than the background of pixels for which the distance—respectively separating them from one of the pixels for which the value of the likelihood attribute has been previously replaced by the value corresponding to an undetermined pixel—is less than or equal to a predetermined value and replacement of the likelihood attribute values with which they are respectively associated by said estimates.

FIG. 7 illustrates the optional filtering step 103. It is assumed that the method 100 comprises a thresholding step to distinguish pixels describing the object, pixels describing the background and undetermined pixels.

Step 1) consists in identifying “problematic” pixel pairs. Indeed, after step 102, boundary pixels describing an object must be directly adjoining pixels describing the background or describing said object. A problematic pixel will be a pixel describing the object which is directly adjacent to an undetermined pixel. These types of aberrations sometimes imply the presence of a text object in which certain letters have not been closed or a nonhomogenous background for which certain ink or texture transitions have been detected in step 101. By way of example, the ternary representation RV described in FIG. 1 (used as a starting point by the process described in FIG. 7) presents text in which the letter “ [symbol] ” is described by pixels associated with likelihood attributes the values of which indicate that the pixels describe an object (black in colour). Some of these pixels (particularly those located around the top loop of the letter) are directly adjoining undetermined pixels (hatched regions).

Step 2) of 103 again re-initialises the representation RT (or alternatively initialises a new transition representation which could be named as a representation of zones of interest) and modifies it such that the values of the transition attributes assigned respectively to the problematic pixel pairs are replaced by the value indicating a detected transition (e.g. value “1” rather than value “0” indicating the absence of a transition). The transition attributes now indicate that the pixels respectively associated with them correspond to a detected transition. These pixels are shown in the schematic of FIG. 7 in the RV1 view. This view depicts the pixels—describing the object—adjoining the pixels describing the background, in black. Pixels describing the background and undetermined pixels are depicted in white. Lastly, the hatched zones depict problematic pixels which have been newly declared to be “transition pixels”.

This step 2) may also consist in increasing the sizes of the pixel regions for which one wants to re-estimate the values of the likelihood attribute by replacing the values of the transition attributes—by the value indicating a detected transition—respectively associated with pixels adjoining undetermined pixels, themselves adjoining pixels which were previously estimated to describe the object and which one would like to newly determine. This operation is shown in the RV2 view of the schematic in FIG. 7. The hatched zones describe the pixels affected by this modification of likelihood attributes. This view shows, in black, the pixels respectively associated with likelihood attributes the values of which respectively indicate that the pixels describe the object at the end of step 102—after thresholding. The pixels for which the respective values of the attributes indicate the background or indeterminacy are represented in white.

Lastly, step 2) of 103 consists in extending the pixel regions for which one wishes to re-estimate the likelihood attribute values, replacing the values of the transition attributes—by the value indicating a detected transition—respectively associated with determined pixels adjoining the pixels previously estimated to describe the object and which one would like to newly determine. View RV3 of the schematic in FIG. 7 uses hatched zones to describe the pixels for which the transition attribute values respectively associated with them have been replaced by the value indicating a detected transition.

Step 3) of 103 consists in newly estimating—in a similar manner to the estimation method described for step 102—the probabilities of representing the object rather than the background of pixels located at a distance less than or equal to a certain distance from pixels which are newly considered to describe a transition and replacing the values of the associated likelihood attributes with the newly estimated probabilities. This step 103 can be repeated in order to reduce the number of problematic pixels (or to eliminate them). The obtained likelihood representation RV′ is a “filtered” likelihood representation and will not have problematic pixels (or very few).

The present exploitation of the transition representation—see above—to identify problematic pixels and their adjoining pixels and to re-estimate certain probabilities is somewhat removed from the original purpose of the transition representation. However, this embodiment allows for the optimisation of the memory storage capacity of the system implementing the classification method.

The invention provides that step 2) of 103 may alternatively consist in initialising a new representation which we could, for example, name the “zone of interest representation”. According to this embodiment, this new representation replaces the transition representation. It allows each source image pixel to be associated with a zone of interest attribute, the binary value of which can be used to identify source image pixels respectively adjoining—or being the neighbour of—a problematic pixel pair—the neighbourhood being defined as a window of predetermined dimensions centred on one of the pixels of said pair and defined by the connected pixels with the same label (i.e. describing the object or being undetermined). It is possible to identify zones (or regions) of pixels of interest detected in this way.

Step 3) of 103 then returns—according to this alternative embodiment—to estimating the respective probabilities of describing the object rather than the background of pixels advantageously respectively associated with transition attributes indicating that said pixels correspond to a detected transition and for which the distance—respectively separating them from one of the pixels for which the value of the zone of interest attribute indicates that said pixel corresponds to a detected zone of interest—is less than or equal to a predetermined value. The values of the likelihood attributes respectively associated with them are replaced by the estimated probabilities.

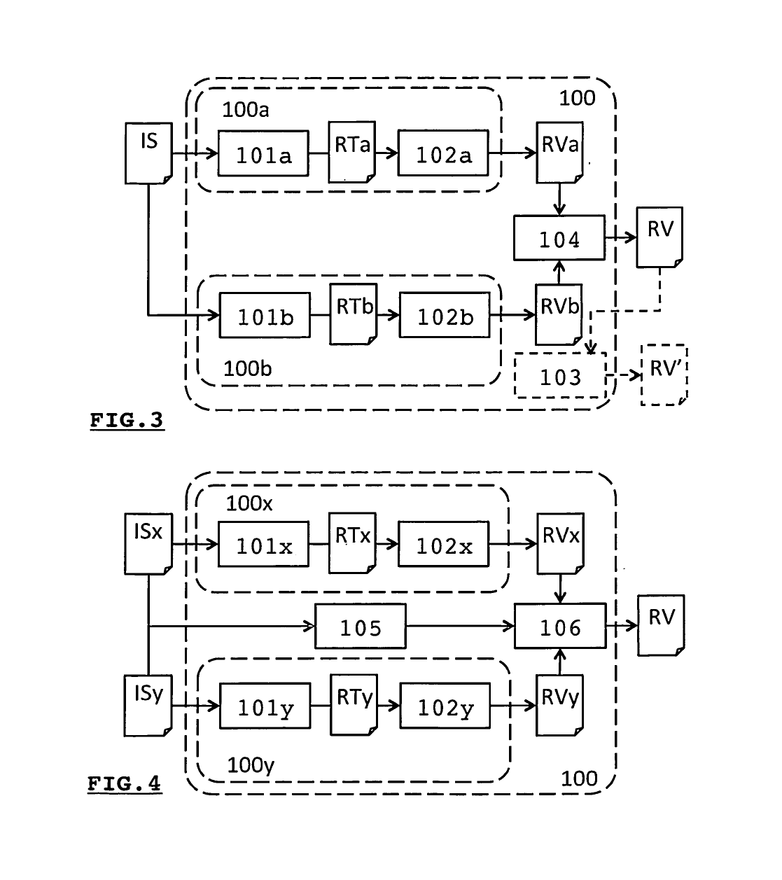

FIG. 3 describes a second embodiment for implementing a method 100 to classify the pixels of a source image describing an object on a background in order to refine the pertinence of the likelihood representation produced, if needed. The advantage of this approach is particularly to limit the false detection of objects due to noise or open letters.

This method (100) is also intended to be performed by a processing unit of an image segmentation system, said processing unit cooperating with storage means. It consists in the performance of a first instance 100a of a method to classify the pixels of interest in a source image according to the invention (e.g. as described previously according to one of the alternative embodiments) in which the sensitivity parameter is chosen in such a way as to prevent any false detection of transitions. In order to achieve this, the method 100a implements a step 101a to produce a transition representation RTa. The contents of this representation can be analysed to possibly lead to a new iteration of 101a in order to refine the choice of the sensitivity parameter. The latter will be such that, while not all transitions can be detected, those transitions that are detected will all be pertinent.

The method 100a comprises a step to estimate the probabilities of describing the object rather than the background of pixels of interest (i.e. those adjoining detected transitions). The instance 100a produces a first likelihood representation of the source image IS.

The method 100 described in FIG. 3 also comprises the performance of a second instance 100b of a method to classify the pixels of interest of the source image IS for which the sensitivity parameter is chosen to prevent any transitions going undetected. Similarly as for instance 100a, 100b comprises a first step 101b (which can be repeated) to produce a transition representation RTb according to which, while some transition detections will occur due to noise or variations in the ink or texture of the background, no actual transitions will go undetected. A step 102b—similar to 102a—produces a second likelihood representation RVb of the source image IS.

In order to produce (and possibly store) a consolidated representation RV of the source image, the method 100 (described in FIG. 3) comprises a step 104. This step consists in assigning to each likelihood attribute of said consolidated representation the respective likelihood attribute values of the first likelihood representation RVa. Alternatively, this operation returns to considering RVa as the basis for the future consolidated representation RV. Values for the likelihood attributes of said consolidated representation are replaced by the likelihood attribute values of the second likelihood representation—respectively associated with the same pixels of the source image—if, and only if, said values are strictly above a certain threshold. This threshold may be set at 0.5 for example, or a higher value. Alternatively, the invention provides that the value of a likelihood attribute of the consolidated representation is replaced by the value of the likelihood attribute of the second likelihood representation—respectively associated with the same pixel of the source image—if, and only if, said value is strictly higher than that of the likelihood attribute of the consolidated representation. The result of this operation is the consolidated likelihood representation. According to an advantageous embodiment, such a method 100 may additionally comprise a step 103 to filter the consolidated representation RV. This step will be similar to step 103 previously described in FIG. 2.

The invention provides a new alternative embodiment which may further increase the accuracy and pertinence of the likelihood representation produced. This third embodiment is described in the block diagram in FIG. 4. According to this third method, a method 100 classifies the pixels of a source image ISx in order to provide a consolidated likelihood representation RV indicating the probabilities that pixels of interest describe the object rather than the background. Such a method is intended to be carried out by a processing unit of an image segmentation system, said processing unit cooperating with storage means. In addition to the source image ISx, the storage means also store a second image ISy. The two images ISx and ISy describe the same object on the same background or, more generally, the same scene. These images may have been captured by identical, similar or different capture means. They may have been selected within a video sequence. However, the capture means producing ISx and ISy must have been displaced by a certain non-zero displacement distance between the two captures (or positioned a non-zero distance apart if different capture means are used).

The classification of pixels of interest, for example, from a video sequence comprising images overlap strongly each other can allow to use redundant information contained in these images.

The method 100—described in FIG. 4—comprises a step 100x to produce and store in storage means, a likelihood representation RVx of the first source image ISx. This representation comes, for example, from the performance of steps 101x (producing a transition representation RTx) and 102x respectively, similar to those described in FIG. 2. The representation RVx may alternatively be produced according to a method described in FIG. 3. RVx associates a likelihood attribute corresponding to a probability that the pixel describes the object rather than the background, with each pixel of the image ISx.

The method 100 comprises a second instance of a method to classify the pixels of interest of a source image such as those described above (i.e. in FIG. 2 or FIG. 3). However, this second instance always concerns the image ISy. A likelihood representation RVy of the second source image ISy is produced in 102y (arising from the intermediate production 101y of a transition representation RTy).

The respective productions of likelihood representations RVx and RVy are preformed jointly with a step 105 to estimate the displacement distance of the capture means. It then becomes possible to establish or determine a correspondence (or a matching) between the pixels of the two images ISx and ISy, and subsequently between the likelihood attributes respectively associated with them. The displacement distance may be derived by estimating an optical flow, estimating a homography, estimating a translation etc. The choice of the displacement and its estimation may be made freely and do not limit the invention.

The method 100 (described in FIG. 4) also comprises a step 106 to produce and store the consolidate likelihood representation RV. This production consists in assigning to each likelihood attribute of said consolidated representation the respective values of the likelihood attributes of the first likelihood representation RVx (or more generally, to consider RVx as the basis for the future RV) then to replace the likelihood attribute values of the consolidated representation RV (or RVx) by a linear combination (e.g. a calculation of the average or the median etc.) of the likelihood attribute values corresponding to the first and second likelihood representations RVx and RVy.

The invention provides that such a method can comprise the production of intermediate likelihood representations (other than RVx and RVy). This only requires that a larger number of source images describing the same scene are subjected to pixel classification according to the invention.

The invention also provides that the method 100 can comprise a prior step (not shown in FIG. 4) to increase the resolution of the source images ISx and ISy (or additional images). Advantageously, this operation may consist in increasing the resolution of the images by interpolation and respectively replacing the source images by the interpolated images. The latter are processed in a similar fashion to the images ISx and ISy.

The invention provides for another embodiment in which the resolution increase is not performed on the source images but directly on the representations RVx and RVy produced.

Such a method 100 described in FIG. 4 may also comprise a filtering step (similar to the step 103 described in FIG. 2) to filter the consolidated representation RV produced.

Whatever the embodiment (or the respectively associated embodiments) chosen to classify the pixels of interest of a source image and to produce a likelihood representation according to the invention, it now remains to determine the pixels of said source image which are respectively associated with likelihood attributes, the common value of which indicate indeterminacy.

As such, the invention concerns—according to a second objective—an innovative method to determine said pixels. Such a method is intended to be carried out by a processing unit (possibly different from that implementing a method to classify the pixels of interest) of a system to segment an image presenting an object on a background

FIG. 5 describes an example of an implementation of such a determination method 200, the purpose of which is to segment an entire source image—for which a likelihood representation RV is available—in order to produce a binary representation RB. Such a binary representation (of the type described in FIG. 1) associates with each pixel of the source image, an attribute the value of which is a predetermined value associated with the background or a predetermined value associated with the object.

Such a method 200 comprises a first step 201 to interpret a likelihood representation RV such as the one produced by a method 100 described in one of the FIGS. 2 to 4. This step 201 characterises a region of connected pixels respectively associated with likelihood attributes indicating indeterminacy, replacing the value of said likelihood attributes by the average of the likelihood attribute values respectively associated with the boundary pixels, for which the respective likelihood attribute values are different from the value indicating indeterminacy. As such, if a region of undetermined connected pixels is surrounded by pixels which mostly describe the background, the likelihood attribute value respectively associated with the undetermined pixels will be the average value of the values of the attributes of the boundary determined pixels. The newly determined pixels will homogenously describe the background (or more precisely, the value of their likelihood attributes will indicate a low probability that said pixels describe the object rather than the background). Conversely, if a region is surrounded by pixels the likelihood attributes of which indicate a high probability that they describe the object, the likelihood attributes of the undetermined pixels will record the average value of the likelihood attribute values associated with the boundary pixels. The newly determined pixels will therefore be considered as probably describing the object.

In the event that said average is close to “0.5”, the likelihood attributes respectively associated with the connected pixels of such a region will confirm weak determinacy. The likelihood representation RV produced at the end of the step 201 allows for the determination of each pixel of the source image.

In order to arrive at a binary representation RB such as that described in FIG. 1, the method 200 comprises a step 202 thresholding the obtained likelihood representation RVd. This thresholding may advantageously consist in assigning to the likelihood attributes, predetermined values respectively associated with the background or the object when the corresponding likelihood attribute values are strictly lower than a background threshold or strictly higher than an object threshold, said thresholds being predetermined. According to a preferred embodiment, the predetermined values respectively associated with the background and the object may be “0” and “1”. The background threshold and the object threshold may also be set respectively and advantageously at 0.5. This embodiment allows the pixels to be categorised into two distinct categories: that of the pixels describing the background (for which the estimated likelihood attributes are lower than 0.5) and that of the pixels describing the object (for which the estimated likelihood attributes are higher than 0.5). The representation RB is binary. Each pixel of the source image may be coded in a bit. This representation may be interpreted as a binary image as with the image RB shown in FIG. 1. The segmentation quality is excellent. This may be performed by a mobile device acting as a segmentation system as the processes are optimised. Any other method of thresholding or encoding the binary representation may be used in another embodiment.

A segmentation system may therefore implement a global segmentation method 300 as summarised in FIG. 6. Such a method corresponds to a segmentation process such as the one described in FIG. 1. It implies the carrying out of a method to classify the pixels of interest of a source image according to the invention (e.g. a method 100 such as that described in FIG. 2). This comprises a first step 101 to analyse a source image IS and to produce a transition representation RT. Then, this is exploited by a step 102 to produce a likelihood representation RV associated with the pixels of the source image IS. The representation RV may also be produced according to an alternative embodiment according to the invention (e.g. according to a method such as that described in FIG. 3 or in FIG. 4). In order to determine all of the pixels of the source image IS, the method 300 implements a process 200 for processing undetermined pixels using the method 100. As such, a first step 201 produces a likelihood representation determining all the pixels of the source image. In 202, this representation is processed using thresholding to provide a binary representation RB.

The method 300 may be performed in its entirety by a segmentation system comprising a processing unit cooperating with storage means (local or remote). In one embodiment, the invention provides that the sub-processes (method 100 and 200) can be carried out by distinct processing units, either successively or at separate times.

The quality of the binary representation obtained may possibly be improved by the optional use of a filtering step (or “deblurring”—not shown in FIG. 6). A nonlimiting example of such an operation may consist in applying the well-known Wiener filter. This filter may be applied indistinctly to the binary representation RB or to the likelihood representation RVd before thresholding.

In order to be able to adapt an image segmentation system such that the latter implements a method according to the invention, this latter must provide a computer program comprising a plurality of instructions operable by a processing unit of said segmentation system. This program is intended to be stored in storage means cooperating with said processing unit. The instructions of the program are such that they trigger the performance of a method according to the invention when executed or interpreted by the processing unit. Different programs—or a main program supported by function libraries—may be used instead of a single program. Similarly, the invention provides that said program may be stored or distributed on non-volatile storage means intended for this purpose.

1. Method to classify the pixels of a source image describing an object on a background, said method being carried out by a processing unit of an image segmentation system, said processing unit cooperating with storage means, said method comprising a step to produce and store in said storage means a likelihood representation of said source image associating a likelihood attribute with each pixel of the source image, the value of which corresponds to a probability that said pixel describes the object rather than the background, said step comprising:
a step to initialise the respective values of the probability attributes to a predetermined value indicating that the pixel is undetermined;
a step to detect a transition between first and second pixel regions respectively describing the object and the background, according to a given sensitivity parameter and producing then storing in the storage means a transition representation of the source image associating with each pixel of the source image a transition attribute indicating whether the pixel corresponds to a detected transition or not;
a step to estimate the respective probabilities to describe the object rather than the background of pixels for which the respective distance separating them respectively from a pixel corresponding to a detected transition is less than or equal to a predetermined value and to replace the likelihood attribute values respectively associated with them by said estimates.

2. Method according to claim 1, according to which the likelihood attribute value corresponding to a probability that a pixel describes the object rather than the background is a real number between 0 and 1 and the predetermined value of a likelihood attribute indicating an undetermined pixel is equal to 0.5.

3. Method to classify the pixels of a source image describing an object on a background, said method being performed by a processing unit of an image segmentation system, said processing unit cooperating with storage means, said method comprising a step to produce and store in storage means a consolidated likelihood representation of said source image associating a likelihood attribute with each pixel of the source image, indicating a probability that the pixel describes the object rather than the background, said step consisting in:
a step to perform a first instance of a method according to claim 1 for which the sensitivity parameter is chosen in order to prevent any false detection of transitions, said implementation producing a first likelihood representation of the source image;
a step to perform a second instance of a method according to claim 1 for which the sensitivity parameter is chosen in order to prevent any transitions going undetected, said implementation producing a second likelihood representation of the source image;
a step to produce and store the consolidated likelihood representation of said source image assigning the respective likelihood attribute values of the first likelihood representation to each likelihood attribute of said consolidated representation then replacing the likelihood attribute values of the consolidated representation with the likelihood attribute values of the second likelihood representation if, and only if, said values are strictly higher than a determined threshold.

4. Method to classify the pixels of a source image, said method being carried out by a processing unit of an image segmentation system, said processing unit cooperating with storage means storing first and second source images having been captured by capture means displaced a non-zero displacement distance between the two captures, said method comprising a step to produce and store in the storage means a consolidated likelihood representation of the first source image associating a likelihood attribute with each pixel of said image indicating a probability that the pixel describes the object rather than the background, said step consisting in:
a step to perform a first instance of a method according to claim 1 to produce a likelihood representation of the first source image;
a step to perform a second instance of a method according to claim 1 to produce a likelihood representation of the second source image;
a step to estimate the displacement distance and to determine the correspondence between the pixels of the two images;
a step to produce and store the consolidated likelihood representation assigning the respective likelihood attribute values of the first likelihood representation to each likelihood attribute of said consolidated representation, then replacing the likelihood attribute values of the consolidated representation by a linear combination of the likelihood attribute values corresponding to the first and second likelihood representations.

5. Method according to claim 4, according to which it comprises a prior step to increase the resolution of the two images by interpolation and to respectively replace the source images by the interpolated images.

6. Method according to claim 1 comprising a step to produce a filtered likelihood representation, said step comprising:
a step to interpret the likelihood representation and to identify all directly adjacent pixel pairs, the first of which describes the object and the second being undetermined;
a step to initialise a transition representation of the source image in which only the values of transition attributes respectively associated with pixels of the source image respectively adjoining said pixel pair, as well as those of the values of the transition attributes associated with said pixel pair, indicate that the pixels correspond to a detected transition;
a step to estimate the respective probabilities to describe the object rather than the background of pixels respectively associated with transition attributes indicating that said pixels correspond to a detected transition and for which the distance—respectively separating them from one of the pixels for which the value of the transition attribute indicates that said pixel corresponds to a detected transition—is less than or equal to a predetermined value and to replace the likelihood attributes respectively associated with them by said estimates.

7. Method to segment a source image describing an object on a background, said method being carried out by a processing unit of an image segmentation system, said processing unit cooperating with storage means, said method comprising a step to produce a binary representation of the source image associating an attribute with each pixel of said source image the value of which is a predetermined value associated with the background or a predetermined value associated with the object, said method comprising:
a step to classify the pixels of the source image according to a method according to claim 1 to obtain a likelihood representation of the source image associating a likelihood attribute with each pixel of the source image the value of which corresponds to the probability that said pixel describes the object and not the background;
a step to characterise a region of respectively connected pixels associated with likelihood attributes indicating that they are undetermined, replacing the values of said likelihood attributes by the average of the likelihood attribute values respectively associated with the boundary pixels for which the respective likelihood attribute values are different from the value indicating indeterminacy.

8. Method according to claim 7 comprising a step thresholding the likelihood representation obtained to produce the binary representation assigning to its attributes predetermined values respectively associated with the background or with the object when the values of the corresponding likelihood attributes are strictly less than the background threshold or greater than the object threshold.

9. Method according to claim 8 according to which, the predetermined values respectively associated with the background and the object may be 0 and 1.

10. Method according to claim 8 according to which, the background threshold and the object threshold are respectively set at 0.5.

11. Computer program comprising a plurality of instructions operable by a processing unit of a segmentation system, said program being intended to be stored in storage means cooperating with said processing unit, wherein said instructions trigger the performance of a method according to claim 1 when executed or interpreted by the processing unit.

12. Non-volatile memory means wherein it holds the instructions of a computer program according to claim 11.
